(19) United States
(12) Patent Application Publication
(10) Pub. No.: US 2012/0297478 A1
(43) Pub. Date: Nov. 22, 2012

(54) METHOD AND SYSTEM FOR PREVENTING DNS CACHE POISONING

(76) Inventors: Antony Martin, Nozay (FR); Serge Papillon, Nozay (FR)

(21) Appl. No.: 13/519,606

(22) PCT Filed: Jan. 18, 2011
(86) PCT No.: PCT/EP2011/050636

§ 371 Date: Jun. 29, 2012

(30) Foreign Application Priority Data
Jan. 19, 2010 (FR) 1000199

(51) Int. Cl. G06F 21/00

(52) U.S. Cl. 726/22

(57) ABSTRACT

A method for preventing the poisoning of at least one DNS cache (5_{—}i) within a computer network (B) including several DNS caches (5_{—}1, 5_{—}i, 5_{—}n), this method comprising a step of comparing at least two DNS responses to a DNS query, returned by two different DNS caches.

This invention pertains to security techniques for domain name systems.

Hereinafter, ‘domain name system’ or ‘DNS server’ (for Domain Name System) shall mean any system making it possible to establish a match between a domain name (or host name) and an IP address or, more generally, to find information using a domain name or an IP address.

Additionally, ‘DNS query’ shall mean a message requesting the resolution of a domain name or IP address. The response to a DNS query shall be called a ‘DNS response’ here. In particular, a DNS response may comprise a domain name, an IP address, an error message, or an error code. It should be noted that the resolution of a DNS query concerns any application using the DNS protocol through a computer network such as, for example, Web browsing, e-mail, or a VPN connection.

Because of the large number of domain names (or, equivalently, IP addresses), a DNS server, in reality, can only represent a limited set of data. Therefore, it cannot resolve all domain names. To do so, a distributed system of DNS servers is typically distinguished, in which each DNS server, when it receives a DNS query to which it has no response,
relays this query to one or more other DNS servers in order to provide it with a response in return (recursive method); or
designates another DNS server, which will then be solicited to respond to this DNS query (iterative method).

In order to optimize the response time for future DNS queries, as well as to prevent the overload of a specific DNS server in the distributed system, most DNS servers also act as DNS caches. In other words, a DNS server holds the response obtained for a DNS query in memory, for a TTL (Time To Live) predefined by the DNS server administrator, so as not to carry out this process again later.

However, this DNS cache is vulnerable to an attack commonly known as DNS cache poisoning, (DNS 2008 and the new (old) nature of critical infrastructure, Dan Kaminsky, Mexico, 2009). This attack aims to create a match between a valid (real) domain name of a public machine (www.google.com, for example) and false information (an invalid IP address or false DNS response, for example) that will be stored in the DNS cache.

Once a false DNS response to a DNS query concerning a certain domain is stored in the DNS cache, it will then automatically be the response, for TTL, to later DNS queries concerning the same domain. Therefore, all users of this DNS cache are vulnerable.

In particular, DNS cache poisoning makes it possible to redirect a user to a site whose content may have malicious intent (virus propagation, phishing to collect personal data, or propaganda by redirecting a site to another competing site or to a nonexistent site, for example).

One object of the present invention is to remedy the aforementioned drawbacks.

Another object of this invention is to prevent the poisoning of a DNS cache belonging to a computer network having many DNS caches.

Another object of this invention is to provide a distributed system of DNS caches with a method for preventing a DNS cache poisoning attack with a minimum amount of modification to the system.

Another object of this invention is to propose a method and system for preventing poisoning attacks on DNS caches compatible with the DNS protocol used by DNS caches.

Another object of this invention is to propose an autonomous system for preventing DNS cache poisoning attacks.

Another object of this invention is to improve the consistency of DNS resolution in an Internet Service Provider network.

Another object of this invention is to propose a method for preventing DNS cache poisoning attacks compatible with most Internet Service Provider (ISP) networks.

Another object of this invention is to propose a counter-measure against DNS cache poisoning attacks within a computer network.

Another object of this invention is to improve the computer security provided to users connected to an Internet Service Provider's network.

To that end, the invention proposes, according to a first aspect, a method for preventing the poisoning of at least one DNS cache within a computer network including several DNS caches, this method comprising a step of comparing at least two DNS responses to a DNS query, returned by two different DNS caches.

According to a second aspect, the invention relates to a system for preventing the poisoning of at least one DNS cache in a computer network including several DNS caches, this system comprising an analyzer of at least two DNS responses to a DNS query, returned by two different DNS caches.

Advantageously, this system also comprises a DNS query analyzer equipped with a database of information on DNS queries making it possible to identify the service with which a DNS query is associated.

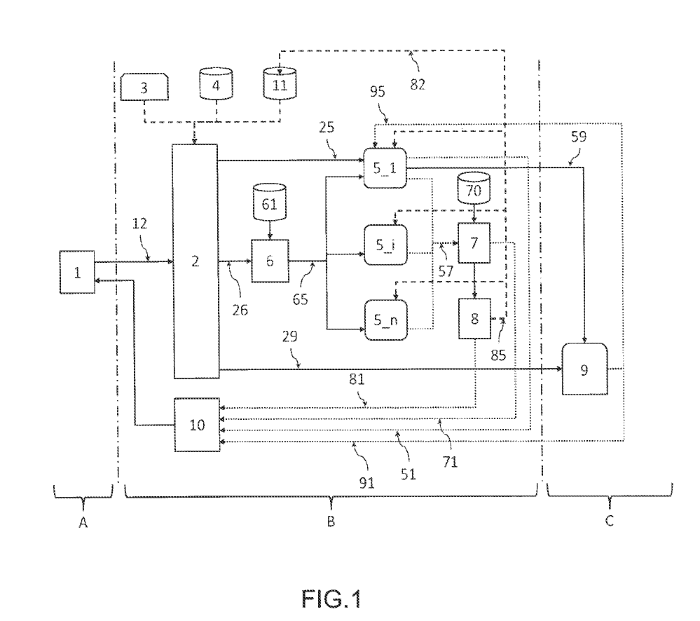

Other characteristics and advantages of the invention will be clearer and more concretely understood after reading the following description of preferred embodiments, where reference is made to FIG. 1 which graphically illustrates the interactions between the modules of one embodiment.

An ISP network B typically comprises several DNS caches 5_1, 5_2, . . . , 5_{—}n (n>1) tasked with responding to DNS queries issued from at least one DNS resolver 1 belonging to a client A connected to the network B. A DNS resolver 1 is typically a client program that formulates DNS queries to be sent to the network B and interprets the DNS responses that are returned to it.

In the event of an inability to respond to a DNS query based on the information available in the DNS caches 5_1, 5_2, . . . , 5_{—}n, the DNS response is solicited from a DNS root server 9 belonging to a name server operator C.

A DNS response is typically communicated to a DNS responder 10 on the network B tasked with relaying this response to the DNS resolver 1, from which the DNS query originated.

A DNS cache management system 3 enables the simultaneous or individual control of the DNS caches 5_1, 5_2, . . . , 5_{—}n. For example, the management system 3 makes it possible to modify the TTL for each DNS cache or to enable/disable a DNS cache.

A poisoning attack on the DNS caches 5_1, 5_2, . . . , 5_{—}n is prevented by using functional modules that can be adapted to any computer network B comprising several DNS caches, in particular one belonging to an Internet Service Provider (ISP).

In particular, these modules comprise:
A DNS query analyzer 2 that decides how to process a DNS query sent from a DNS resolver 1;
A DNS query deconcentrator 6 serving several DNS caches;
A comparator 7 of the DNS responses obtained from several DNS caches;
An analyzer 8 of the DNS responses obtained from several DNS caches; and
Several extensible information databases assisting the poisoning attack prevention system for the DNS caches 5_1, . . . , 5_{—}n.

When the DNS query analyzer 2 receives a DNS query issued from a DNS resolver 1 (link 12 on FIG. 1), the DNS query analyzer 2 decides which processing to carry out to resolve this DNS query. The decision is made based on information retrieved from:
A database 4 with information on DNS queries such as the service (e.g. browsing, e-mail, streaming, e-commerce, and e-learning) and/or the protocol (e.g. HTTP, HTTPS, POP3, FTP, or SMTP) with which the DNS queries are associated;
A database 11 of invalid DNS responses; and
The management system 3 for the DNS caches 5_1, 5_2, . . . , 5_{—}n that can be configured by the administrator of the network B.

The database 4 of information on DNS queries uses the content of a DNS query (in particular, the domain name—for example, ebay.com or google.com—and the transport protocol—for example, HTTP, HTTPS, or SMTP) to identify the service with which this DNS query is associated. For example, if a DNS query comprises
the domain name ‘ebay.com’, the information database 4 identifies this domain name and associates it with an e-commerce service;
the domain name ‘home.americanexpress.com’, the information database identifies this domain name and associates it with an e-banking service;
the SMTP protocol, then the information database associates this query with an e-mail application.

The content of the information database 4 may be previously established manually and/or automatically enriched (automatic learning) with information contained in the DNS queries received. The information database 4 thus makes it possible to distinguish DNS queries assumed to be critical by the administrator of the network B (e.g. an e-commerce/e-banking service or an e-mail system).

In one embodiment, the DNS query analyzer 2 labels each DNS query by level of importance (e.g. ‘critical’, ‘important’, ‘average’, or a number between 1 and 10) based on the service identified by the information database 4.

It should also be noted that the choice of processing to be carried out to resolve a DNS query may be programmed from the DNS cache management system 3 based, for example, on
the time: peak hours or not;
availability of the DNS caches: maintenance, overrun;
the source of the DNS queries: clients with different types of subscriptions;
the service with which a DNS query is associated, e.g. e-commerce, e-banking, e-mail, or VPN.

In one embodiment, three possible processing modes can be distinguished to resolve a DNS query:
The DNS query is sent to a single DNS cache (for example, the DNS cache 5_1 as shown on FIG. 1: link 25);
The DNS query is sent to a DNS query deconcentrator 6 (link 26 on FIG. 1); or
The DNS query is sent directly to the DNS root server 9 (link 29 on FIG. 1).

It should be noted that a DNS response may be obtained from the network B
recursively: upon receiving a DNS query, a DNS server queries its local DNS cache 5_{—}j (1<=j<=n) (for example, DNS cache 5_1 as shown on FIG. 1) concerning this query. If it has a response to this query locally, then this response is sent to the DNS response module 10 (link 51 on FIG. 1). Otherwise, the DNS server takes the role of resolver and transmits the DNS query to another DNS server more likely to have the requested information (in other words, a DNS server for which the probability that it has the requested information is sufficiently high). If no DNS server has the response, the query is finally sent to a DNS root server 9 (link 59 on FIG. 1) from which a copy of the DNS response (link 95 on FIG. 1) will be stored for a TTL in the DNS cache; or
iteratively: if a DNS cache does not have a local response to a DNS query, it asks the DNS resolver 1 to send the query directly to another DNS server more likely to have the requested information. If no DNS server has the response, the query is finally sent to a DNS root server 9 (link 29 on FIG. 1). The DNS response returned by the DNS root server 9 is communicated to the DNS responder 10 (link 91 on FIG. 1).

In another embodiment, the DNS response is obtained in a consolidated manner from several DNS caches as follows:
As soon as a DNS query arrives to the DNS query deconcentrator 6, it is sent to a list of DNS caches (link 65 on FIG. 1) according to distribution criteria stored in a database 61.
The DNS responses obtained by the list of DNS caches are all sent to the DNS response comparator 7 (link 57 on FIG. 1).
Based on the DNS responses obtained, the comparator 7, assisted by an information database 70,
   either sends a DNS response to the DNS responder 10 (link 71 on FIG. 1)
   or sends the results obtained to a DNS response analyzer 8.
The DNS response analyzer 8 studies the DNS responses and then sends one single DNS response to the DNS responder 10 (link 81 on FIG. 1).

It should be noted that the distribution, by the deconcentrator 6, of a DNS query to a list of DNS caches is carried out based on information retrieved from the database 61. The database 61 comprises information on the DNS caches 5_1, 5_2, 5_{—}n on the network B, such as the number, topology, geographic location, IP address, size of the contents, and number of users connected to the DNS caches 51, . . . , 5_{—}n.

Advantageously, based on the data available in the database 61, the deconcentrator 6 can relay the DNS query only to the DNS caches deemed to be relevant. Indeed, in one embodiment, the list of DNS caches to which a DNS query will be relayed by the deconcentrator 6, is selected based on:
Information retrieved from the database 61 such as the location of the DNS servers. For example, by assuming that there is less risk of poisoning, by the same invalid data, of two spatially distant DNS caches, then: the further the DNS cache servers are separated, the greater the likelihood that a DNS response returned by the local DNS cache, identical (determined by the comparator 7) to the DNS response returned by the remote DNS cache, is valid (correct). In particular, this depends upon the topology of the computer network B; and/or
Information provided by the DNS query analyzer 2: for example, if the DNS analyzer 2 marks a DNS query as ‘critical’, then, preferably, a larger number of DNS caches will be queried. In other words, the number of DNS caches to be queried is preferably dependent upon the service with which the DNS query is associated. This also makes it possible to optimize the performance of the DNS response verification process.

Then the DNS response comparator 7 makes it possible to centralize and compare all the DNS responses obtained from the list of DNS caches queried (which is to say, designated by the DNS query deconcentrator 6).

If all the DNS responses are identical, then this DNS response will be sent directly to the DNS responder 10 (link 71 on FIG. 1), which will then send it to the DNS resolver 1 or directly sent to the DNS resolver 1 (without going through the DNS responder 10).

It should be noted that some domains have more than one IP address (or the inverse, which is to say one IP address that matches more than one domain name). in this case, having access to the IP prefixes stored in a database 70 (already allocated to companies, e.g. ebay™, Microsoft™, HSBC™, or YouTube™), the comparator 7 is capable of comparing the IP addresses of sub-networks to distinguish identical domain names. If a DNS response comprises an IP address that is not identified in the database 70, it may then be a potentially invalid DNS response.

It is also possible to use reverse DNS resolution to compare two DNS responses returned by two different DNS caches: requiring, through a DNS cache (5_1, for example), the reverse resolution of a domain name associated with an IP address returned by another DNS cache (5_2, for example). A difference between the two DNS responses proves the poisoning of at least one of the two DNS caches.

If the DNS responses are different, then they are sent to the DNS response analyzer 8. The DNS response analyzer 8
Calculates the ratios of the DNS responses;
Classifies the DNS responses by their ratios; and
Acts accordingly:
   Retaining a DNS response that will be sent to the DNS responder 10 (link 81 on FIG. 1) or directly to the resolver 1 and confirmed by at least the DNS caches queried (link 85 on FIG. 1); or
   In the event that a problem is detected, triggering an action such as: notifying the resolver 1 of a DNS cache poisoning attack, sending an error to the resolver 1, sending nothing to the resolver 1, or triggering an internal alert sent to the administrator of the network B indicating that there is a potential risk of DNS cache poisoning.

Advantageously, the DNS response analyzer 8 may be configured/set up by an administrator of the network B (threshold ratios, or actions to be triggered if a DNS cache poisoning problem is detected, for example).

As an example for illustrative purposes, if there are five DNS responses of which four are identical, the DNS response analyzer 8 deduces the presence of a dominant response that will be transmitted to the DNS responder 10 or directly to the resolver 1.

If there is no consistency among the DNS responses returned by the DNS caches queried—such as if among five DNS responses, only three DNS responses are identical and the two others are different—then the DNS response analyzer 8 cannot conclude that there is a valid DNS response. In this case, the following actions may be undertaken:
Notify the resolver 1 of a potential security problem. This information may be incorporated into the ‘TXT’ field of a DNS response that comprises descriptive information about the domain;
Store the invalid DNS responses (those with low ratios, for example) in the database of invalid DNS responses 11;
Notify the administrator of the network B of a potential DNS cache poisoning attack.

In one embodiment, the DNS response having the highest ratio among the set of DNS responses returned by the DNS caches is considered the DNS response to the DNS query.

If an invalid DNS response is confirmed, it is added to the database of invalid DNS responses 11 (link 82 on FIG. 1). This will make it possible to warn the DNS caches when resolving later DNS queries.

A communication protocol may be defined in accordance with RFC 5507 from the IETF for sending an error notice from the DNS response analyzer 8 to the DNS responder 10 (or equivalently, to the DNS resolver 1).

In the event that a poisoning problem is deduced on one or more DNS caches based on the ratios of the DNS responses, a command to reduce the TTL of the DNS caches in question to 0 can be launched/programmed (for example, reduce the TTL of the DNS caches having returned a DNS response with a low ratio among the set of DNS responses). This command can be immediate: it consists of setting the TTL to 0 immediately. Alternatively, this command may be arithmetic: it may consist of ordering a continuous reduction of the TTL by a predetermined decrement (for example, 1 or 2 seconds). Alternatively, the command may be geometric, and may consist, for example, of ordering the TTL of the DNS caches in question to be divided in half. This command is intended to force the DNS caches to renew their caches. For example, an entry in a DNS cache with a TTL of 3600 seconds can be set to 0 seconds, thus becoming invalid.

Alternative measures in the event of deducing a poisoning problem with one or more DNS caches based on the ratios of the DNS responses, are, for example, the expiration of a DNS zone, or the configuration of a persistent DNS entry in the DNS caches affected by the problem. This makes it possible to guarantee that the incriminated DNS caches return a valid value if they are queried later. This measure is temporary and must be deleted later to allow the dynamic constitution of DNS cache databases.

In one embodiment, the DNS response comparator 7 and the DNS response analyzer are combined into a single functional module.

Advantageously, the DNS response thus obtained is consolidated through several DNS caches.

Advantageously, the method described here makes it possible to prevent a DNS cache poisoning attack through the intelligent use of the DNS cache servers already existing within an ISP network.

In another embodiment, the DNS query deconcentrator 6 relays a DNS query
To at least one DNS cache (DNS cache 5_1, for example) and;
To at least one DNS root server 9
   to then compare the DNS responses that they return. This makes it possible to have one additional entry for the DNS response comparator 7.

Another embodiment making it possible to prevent DNS cache poisoning changes the way in which the validity of the DNS cache contents is verified. In other words, instead of exchanging information using the DNS protocol, another DNS cache content verification protocol is developed.

Advantageously, the embodiments described here use the distributed DNS cache system already in use in most ISP networks.

It should be noted that the embodiments described here are independent of the operating system used by the client A connected to the network B.

In another embodiment, the DNS module 10 is optional, and the DNS responses are therefore transmitted directly to the DNS resolver 1.

In another embodiment, the residential gateways of the ISPs, installed at their customers' homes, are the DNS caches. These residential gateways connected to the operator's network can then combine modules 2, 6, 5_{—}i, and optionally 7, 8, 10, and optionally the databases associated with these modules.

1. A method for preventing a poisoning of at least one DNS cache within a computer network including several DNS caches, the method comprising the steps of:
comparing at least two DNS responses to a DNS query returned by two different DNS caches, and
analyzing the DNS query to identify a service with which said DNS query is associated before querying the DNS caches.

2. The method according to claim 1, wherein a number of DNS caches queried depends upon the service with which the DNS query is associated.

3. The method according to claim 1, wherein the step of comparing the at least two DNS responses further comprises a step of reversing a resolution of the DNS query by at least one DNS cache.

4. The method according to claim 1, wherein the step of comparing the at least two DNS responses further comprises a step of calculating ratios of the at least two DNS responses.

5. The method according to claim 4, wherein the DNS response with the highest ratio among a set of DNS responses returned by the DNS caches is the DNS response to the DNS query.

6. The method according to claim 1, wherein an inconsistency among the at least two DNS responses returned by the DNS caches triggers at least one of the following actions:
notifying a source of the DNS query of a security problem;
notifying a administrator of a computer network of a potential poisoning attack on at least one DNS cache;
storing at least one of the at least two DNS responses in a database.

7. The method according to claim 4, wherein a Time To Live of a DNS cache returning a DNS response with a low ratio among the responses returned by the set of DNS caches is reduced to zero.

8. The method according to claim 1, wherein the at least two DNS responses comprise a DNS response returned by a DNS root server.

9. A system for preventing a poisoning of at least one DNS cache in a computer network including several DNS caches, the system comprising:
an analyzer of at least two DNS responses to a DNS query returned by two different DNS caches, and
a DNS query analyzer, equipped with a database of information on DNS queries, configured to identify a service associated with the DNS query.

10. The system according to claim 9, wherein the at least two DNS responses comprise a DNS response returned by a DNS root server.
